(19) United States
(12) Patent Application Publication
(10) Pub. No.: US 2011/0238327 A1
(43) Pub. Date: Sep. 29, 2011

(54) SPECTROMETRIC CHARACTERIZATION OF HETEROGENEITY

(76) Inventors: E. Neil Lewis, (US); Kenneth S. Haber, (US)

(21) Appl. No.: 13/008,884

(22) Filed: Jan. 18, 2011

Related U.S. Application Data
(60) Provisional application No. 61/295,688, filed on Jan. 15, 2010.

(51) Int. Cl. G01J 3/44; G01J 3/28; G06F 17/18

(52) U.S. Cl. 702/22; 356/326; 356/301

(57) ABSTRACT

In one general aspect, a spectroscopic method is disclosed. This method includes acquiring a plurality of separate spectral measurements at different locations on a sample and evaluating results of the measurements based on one or more predetermined test criteria. Information from measurements made at the different locations is categorized based on results of the step of evaluating, and results are reported that include information from both the step of acquiring and the step of categorizing.

### CROSS-REFERENCE TO RELATED APPLICATIONS

This application claims the benefit under 35 U.S.C. 119(e) of U.S. provisional application No. 61/295,688, filed on Jan. 15, 2010. It is also related to provisional application No. 60/860,345, filed on Nov. 20, 2006, provisional application No. 60/993,141, filed on Sep. 10, 2007, and non-provisional application No. 11/986,548, filed on Nov. 20, 2007, now U.S. Pat. No. 7,864,316. All of these applications are herein incorporated by reference.

### FIELD OF THE INVENTION

This invention pertains to spectrometric instruments, such as spectrometric instruments for characterizing pharmaceutical heterogeneity.

### BACKGROUND OF THE INVENTION

Spectrometric techniques have been applied to monitoring mixing processes, such as the mixing of pharmaceutical blends. One approach has been to take a series of single spectra of a blend through a window in a mixing vessel. Mixing can then be carried out until this single measurement reaches an end point. This method is simple to implement, but it provides the user with relatively little information about the distribution of components of the mixture.

Another approach has been to acquire a series of near-infrared chemical images of a blend in a mixing vessel. These images can then be analyzed to derive statistical properties, such as the mean, standard deviation, kurtosis, or skew of the distribution, as described in more detail in published US application no. US2004-0211861, which is herein incorporated by reference. This approach can provide more information about the distribution of mixture components than does the single-measurement approach, but it can be relatively expensive to implement.

### SUMMARY OF THE INVENTION

A number of different embodiments of the invention are presented in this application and in the attached claims.

In one general aspect, the invention features a spectroscopic method that includes acquiring a plurality of separate spectral measurements at different locations on a sample, evaluating results of the measurements based on one or more predetermined test criteria, categorizing information from measurements made at the different locations based on results of the step of evaluating, and reporting results that include information from both the step of acquiring and the step of categorizing.

In preferred embodiments the step of categorizing can be performed by rejecting one or more measurements that fail to satisfy the predetermined test criteria. The step of categorizing can be performed by classifying the measurements into a plurality of discrete categories. The step of categorizing can be performed by associating the measurements with categorization information. The predetermined test criteria can be statistical test criteria. The step of categorizing can include the steps of retaining measurements for the locations that meet the predetermined test criteria and rejecting measurements for the locations that fail to meet the predetermined test criteria. The method can further include the step of deriving one or more statistical properties of the categorized measurements. The step of deriving statistical properties can include a step of averaging the categorized measurements. The step of deriving statistical properties can include a step of obtaining a standard deviation for the categorized measurements. The step of deriving statistical properties can include a step of obtaining a kurtosis value for the categorized measurements. The step of deriving statistical properties can include a step of obtaining a skew value for the categorized measurements. The step of acquiring can include acquiring scout measurements and test measurements, with the step of categorizing including retaining information from test measurements at locations that satisfy the test criteria in the scout measurements. The measurements can include Raman measurements. The step of evaluating results of the measurements can be adapted to detect fluorescence, and the step of categorizing can be operative to reject measurements where fluorescence is detected. The step of evaluating can detect measurements that exceed a predetermined intensity threshold. The sample can be moved relative to the detector to allow the detector to acquire the separate spectroscopic measurements from the different locations. The steps of acquiring can be performed using at least one moving minor. The moving mirror can image at least a portion of an illuminated area of the sample onto an aperture between the sample and the detector. The steps of acquiring and deriving can be performed for a pharmaceutical mixture. The steps of acquiring and deriving can be performed for a pharmaceutical product. The steps of acquiring and deriving can be performed for a pharmaceutical intermediate. The steps of acquiring and deriving can be performed for a pharmaceutical dosage unit. The step of acquiring can acquire a Raman measurement. The sample can be moved relative to the detector to allow the detector to acquire the sampled spectroscopic measurements from the different locations. The size of the samples can be on the order of the milled ingredient size for a pharmaceutical mixture. The size of the samples can be on the order of the domain sizes of individual species in a pharmaceutical mixture. The size of the samples can be on the order of 10 microns. The size of the samples can be on the order of 125 microns. The size of the samples can range from 0.5 microns to 1000 microns.

In another general aspect, the invention features a spectroscopic apparatus for monitoring heterogeneity of a sample, that includes a sampling detector operative to acquire sampled spectroscopic measurements distributed over a range of different locations in a sample, a sequencer operative to cause the same sampling detector to successively acquire samples for each of a plurality of locations in the sample, and a spectral processor operative to derive from the sampled spectroscopic measurements a statistical measure of chemical heterogeneity.

In a further general aspect, the invention features a spectroscopic apparatus for monitoring heterogeneity of a sample, that includes means for acquiring sampled spectroscopic measurements distributed over a range of different locations in a sample, means for causing the sampling detector to successively acquire samples for each of a plurality of locations in the sample, and means for deriving from the sampled spectroscopic measurements a statistical measure of chemical heterogeneity.

### BRIEF DESCRIPTION OF THE DRAWINGS

FIG. 1 is a diagram of an illustrative embodiment of a spectrometric pharmaceutical heterogeneity characterization system according to the invention;

FIG. 2 is a flowchart illustrating the operation of the system of FIG. 1;

FIG. 3A is a first illustrative sampling map for the system of FIG. 1;

FIG. 3B is a second illustrative sampling map for the system of FIG. 1;

FIG. 4 is a diagram of a scanning-mirror implementation of a detector element for the system of FIG. 1;

FIG. 5 is a diagram of a fiber-bundle implementation of a detector element for the system of FIG. 1;

FIG. 6 is a series of micro distribution plots for a series of samples for the system of FIG. 1;

FIG. 7 is a plot of average concentration for the samples shown in FIG. 6;

FIG. 8 is a plot of macro distribution for the samples shown in FIG. 6;

FIG. 9 is a first illustrative sampling map for a system employing differently sized sample locations; and

FIG. 10 is a partial system diagram for an embodiment of the system that can produce sampling maps according to FIG. 9.

### DESCRIPTION OF AN ILLUSTRATIVE EMBODIMENT

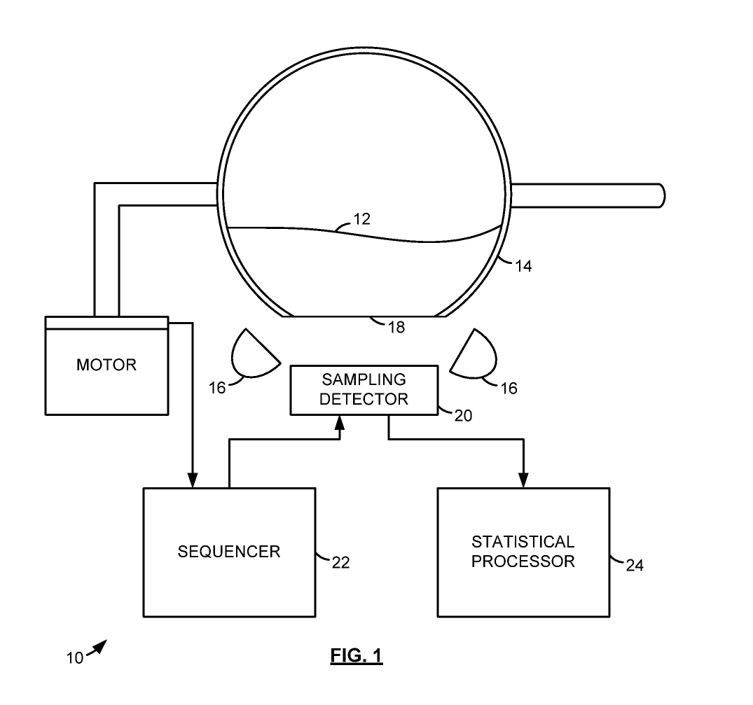

Referring to FIG. 1, an illustrative system 10 according to the invention is designed to characterize the mixing of a pharmaceutical powder blend 12 in a motor-driven mixing vessel 14, such as a V-blender. Other types of processing devices could also be accommodated, however, such as hoppers or granulators. And other types of pharmaceutical mixtures or dosage units can be characterized, such as solid dosage forms (e.g., capsules or tablets), suspensions, or even mixtures of immiscible fluids.

The system 10 includes one or more infrared illumination sources 16 directed toward a window 18 in the mixing vessel 14. One or more sampling detectors 20 are positioned near the vessel in such a way that they can acquire spectrometric samples through the window. A sequencer 22 can trigger acquisitions by the sampling detector, and a statistical processor 24 can receive the acquired samples.

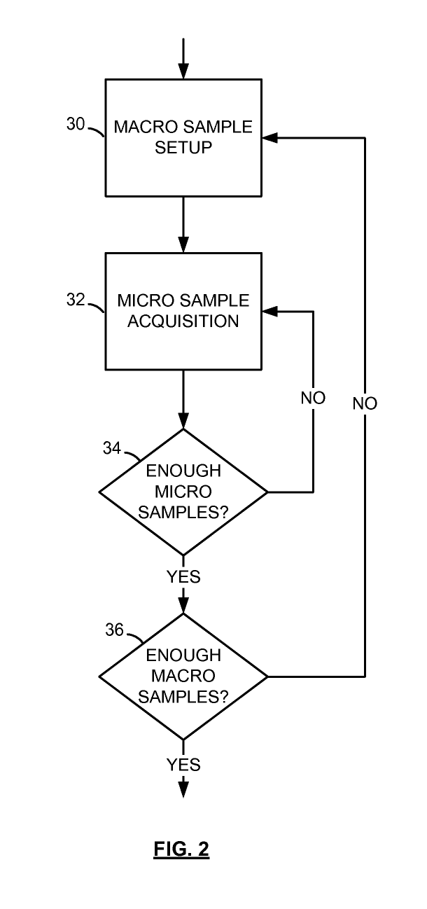

Referring also to FIG. 2, the system 10 is first put in an initial macro-sampling state (step 30). In the illustrative embodiment, this state is one where the blender window 18 is in front of the sampling detector 20. The system then performs a series of micro-sample acquisitions (step 32). Once the micro-sampling is complete (step 34), the system mixes the blend until another macro-sampling state is reached, and the system begins another series of micro-sampling acquisitions.

The acquisition process ends at the end of a final macro-sample (step 36). This can be the last of a predetermined number of macro-samples in a fixed sampling schedule. The system can also stop the process for other reasons, such as once certain predetermined mixing characteristics have been achieved, or when an error condition is detected.

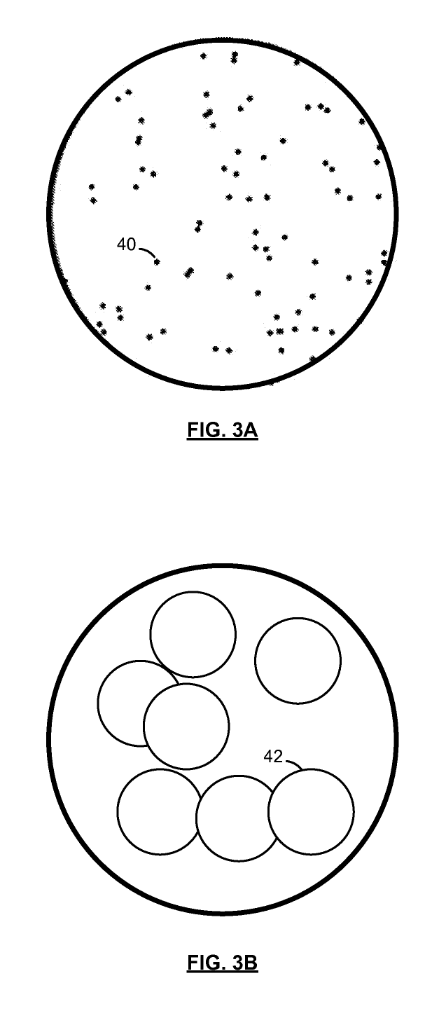

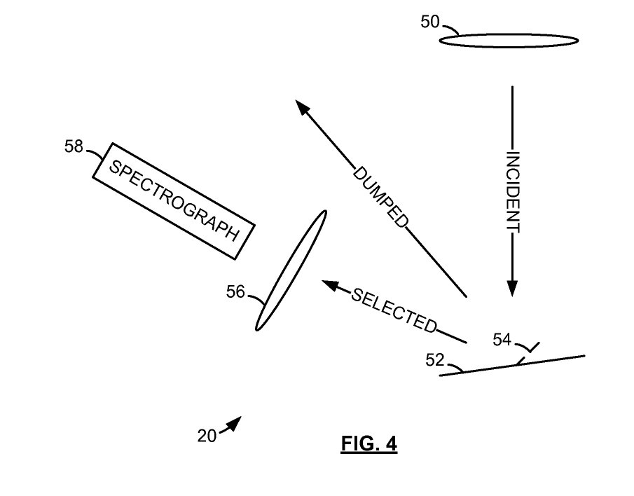

Referring also to FIG. 3A-3B, the sampling detector is designed to acquire a number of micro-samples at different locations in the sample during each macro-sample period. The system can use one or more different types of sampling patterns, such as random patterns of non-overlapping samples 40 or overlapping samples 42. The sequencing of the acquisition of the samples is generally defined by the nature of the detector and its sequencer.

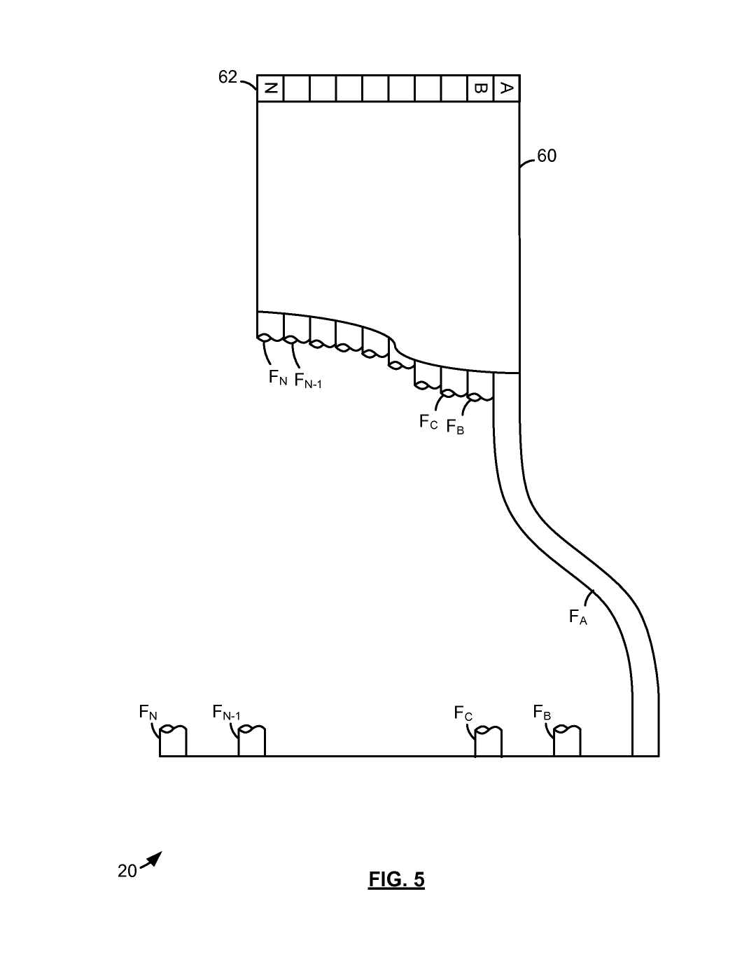

Referring also to FIG. 4, one possible implementation of the sampling detector 20 that can perform the micro-sampling operations is based on a micromirror array. In this implementation, lamps at an oblique angle are used to illuminate the entire sampled area. A collection lens 26 images the sampled area onto a micromirror array 52, oriented so that in one state the minors reflect the incident light into a beam dump. In the other state the mirrors (see 54) reflect the light into a lens 56 which images the micromirror array onto the slit of a spectrograph 58 equipped with a diode array detector. Alternatively, the aperture may be imaged onto the round face of a fiber bundle, which is round on one end and linear on the other end, with the linear end serving as the slit for the spectrograph.

In a second implementation the illumination is as above, but an optical system which includes a scanning mirror images a portion of the illuminated area onto an aperture. This aperture is then imaged onto the slit of the spectrograph or onto a fiber bundle as described above. The spatial resolution is determined by the size of the aperture projected through the collection optics onto the sample. The aperture may consist of an iris, slit, wedge or a small mirror, positioned to pick off only a small portion of the sample image.

In a third implementation the oblique illumination is provided by the modulated light from a Fourier Transform (FT) interferometer, and the micromirror array selectively images a portion of the illuminated area directly into a single element detector.

In a fourth implementation the illumination is the modulated light from an FT interferometer, and an optical system which includes a scanning mirror images a portion of the illuminated area onto an aperture which is imaged directly onto a detector.

In a fifth implementation a beamsplitter is used to couple a collimated broadband beam into the collection path. The light is telescoped down and sent through an aperture, which is imaged to a spot on the sample by an optical system which incorporates a scanning mirror. Light from that spot follows the same path back to the beamsplitter and is then focused onto the slit of a spectrograph.

As before, the collimated broadband illumination source can be the modulated output of a Michelson interferometer, in which case the spectrograph is replaced by a single element detector.

Instead of telescoping the illumination beam to the size of a small aperture, the entire collimated excitation beam can illuminate a micromirror array oriented so that an minor in the ‘on’ state will direct a portion of the collimated incident beam to a corresponding spot on the sample, and the reflected light from that spot will be directed to the beamsplitter and then to either the slit of the spectrograph or into a detector in the case of FT illumination. The spot could also be brought to the sample through the use of an optical microscope.

In still another configuration, a spectrograph (or a detector for the case of FT modulated illumination) can be set up to collect light from a large area, and a small portion of that area can be illuminated oblique to the collection angle, either using a micromirror array or by again making use of the small aperture—scanning minor-lens combination described earlier.

Sampling at different locations can also be achieved by moving the material to be sampled instead of moving the sampling locations with respect to the instrument. A dosage unit could be rotated or tumbled, for example, in front of a single-point detector. A x-y stage could also be moved randomly with respect to a detector.

Sampling can also take place from different vantage points. Different sample locations could be acquired from opposite sides of a tablet, for example, by different detectors, optical conduits, mirrors, or other suitable arrangements.

Referring to FIG. 5, another possible implementation of the sampling detector 20 employs an optical fiber bundle 60, with one end positioned next to a relatively small one- or two-dimensional array. The fibers from the other end of the bundle are spread out and positioned to acquire micro-samples from different locations in the blend. Broad area illumination could also be imaged onto the face of a fiber bundle which is round at one end and linear on the other end. For FT illumination the linear end would be imaged directly onto a diode array. For unmodulated illumination the linear end would form the entrance slit of an imaging spectrograph, and a 2-D array detector would collect the spectral and spatial information on different axes.

The sequencing of acquisitions can take place in any suitable manner. It can use a computer program or dedicated circuit or a combination of the two. It can also use other types of principles, such as optical, mechanical, or electro-optical principles. In the embodiment of FIG. 1, for example, the sequencer can receive a position signal from a shaft encoder on the blender motor to synchronize macro acquisitions with the position of the blender. In some situations, the sequencer functions may even be impossible to isolate from the sampling detector. A sampling detector that is designed with a suitable mechanical resonant frequency, for example, can be allowed to simply run free in the acquisition of micro-samples.

Referring to FIG. 6, as the mixing process proceeds, each set of micro-samples exhibits a different set of statistical properties. Typically, the standard deviation of the acquired spectra will narrow as the mixture becomes more uniform. The mean will also tend to shift, reflecting the distribution of all of the mixture components throughout the vessel.

The statistical techniques performed by the statistical processor 24 can be applied to raw spectral data, or derived values, such as chemical or physical properties. The statistical properties can be computed as the micro-samples are being acquired and/or after a full run.

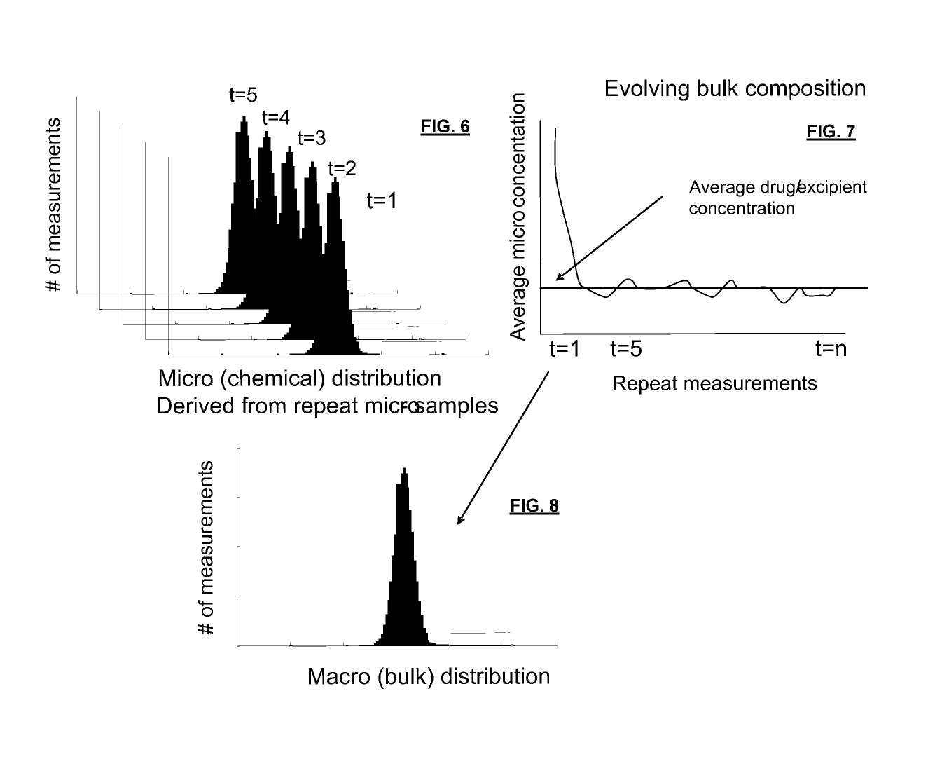

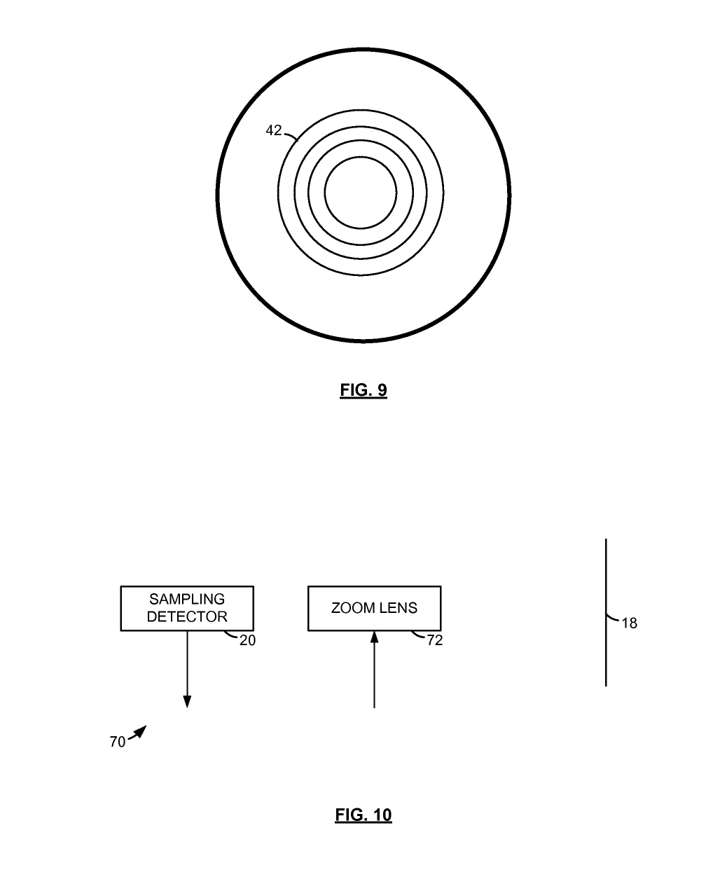

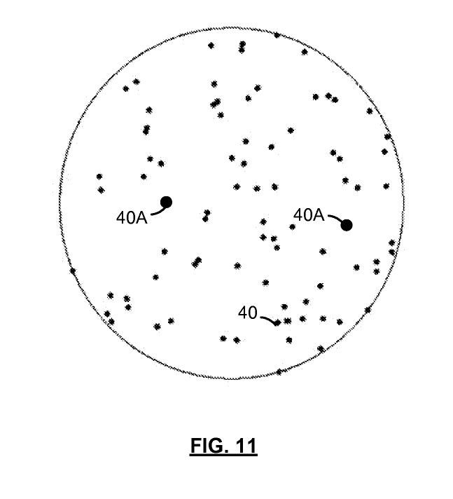

Referring to FIG. 7, the evolution of one or more of the statistical properties can be determined to characterize the process. This information can then be displayed to the user, and it can also be used in a variety of other ways, such as to decide whether a mixture has reached an end point. As shown in FIG. 8, the statistical information from the micro-macro-sampling process can also be presented as overall bulk distribution statistics.

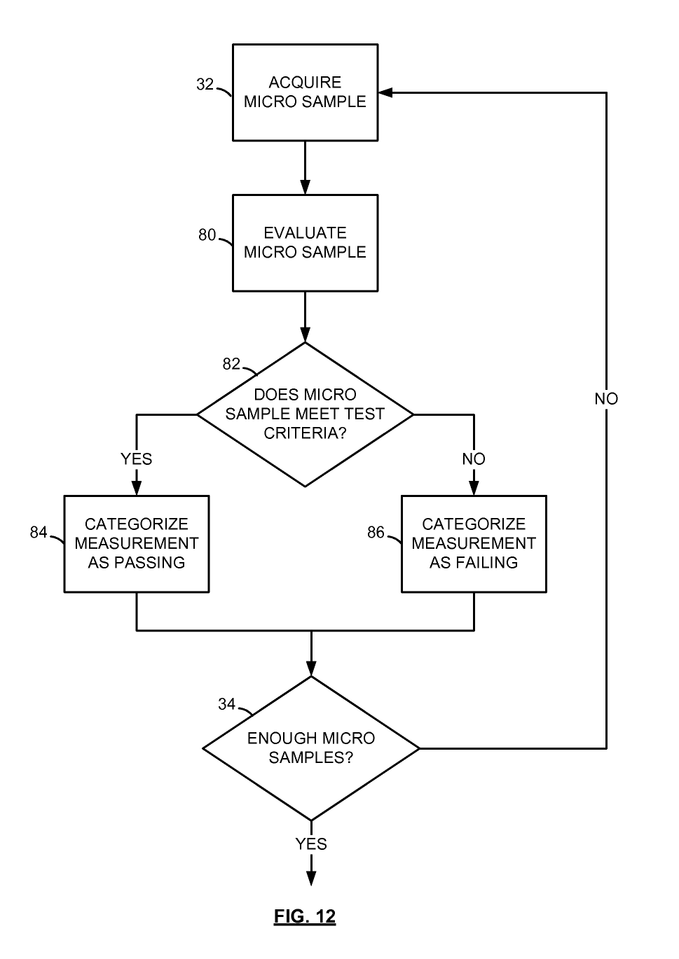

Referring to FIG. 9, the system can also acquire samples of differently sized micro locations. These micro locations can be concentric or otherwise overlapping, or they can be distributed around the sample.

Referring to FIG. 10, one approach to acquiring samples from differently sized micro locations is to introduce an electrically controlled zoom lens between the detector 20 and window 18 or other sample target. In this embodiment, the modified system 70 alternates between acquiring a measurement and adjusting the magnification of the zoom lens to assemble a series of measurements corresponding to differently sized micro locations. Such a series could also be obtained in a variety of other ways. For example, the system could illuminate different amounts of the sample, actuate different numbers of minors in a mirror array, and/or acquire light from different numbers of fibers.

Acquiring measurements from differently sized locations can provide additional information about the distribution of particles in a sample. Measurements over large areas will generally be representative of a number of different particles and will therefore reflect an average for these particles. Measurements over areas that are similar in size to individual particles will tend to reflect a single species. As size decreases in a series of measurements, therefore, the acquired spectrum will generally evolve from showing a mixture of species to showing just spectral features corresponding to an individual species. Chemometric analysis techniques can also be applied to the series of measurements to derive more detailed information about particle size and relative ingredient concentrations.

Referring to FIG. 11, the system can also test and classify micro-sample measurements for one or more macro-samples. This can be useful in improving the accuracy of results from a variety of types of independent or macro-sampled measurements. The tests can be statistical, such as to exclude small numbers of outliers. The tests can also be designed to exclude measurements arising from particular predetermined kinds of situations, such as where a small number of fluorescing contaminant particle samples 40A swamp out the others in a Raman measurement. Other suitable types of tests could be developed by one of ordinary skill in the art to improve measurements in a variety of different situations based on the specific conditions in which they are to be taken.

Referring to FIG. 12, the system begins by acquiring a micro-sample (step 32). This sample is then evaluated (step 80). This evaluation can be based on any of a number of different criteria. In the case of a Raman measurement, for example, the evaluation can be designed to detect an unusually high intensity level so that small amounts of fluorescing contaminants can be excluded from a final average of micro-samples.

If the micro-sample meets the test criteria it is classified as passing (step 84). If the micro-sample does not meet the test criteria it is categorized as failing (step 86). The categorization of measurements can range from a simple pass-fail determination to a more complex multi-class categorization, or even a continuous categorization. The categorization process be performed in a variety of ways, such as retaining or discarding sample measurement values, storing different types of sample measurements in different parts of a data structure, or associating categorization information with each sample.

This categorization technique can be used in situations where one or more macro-sample is desired (see step 34). It is also possible to perform separate macro-sample runs for evaluation and final measurement purposes. A first scout pass might be performed to find outliers, for example, with a second pass then being performed to acquire measured values. The scout pass could be performed in a different way than the measurement pass (e.g., more quickly or with a different measurement range).

The categorized micro-sample data set can then be reported to the user or to another system component. This reporting step provides information from the measurement and its categorization. For example, it can include passing samples and exclude failing samples, it can weight some of the samples more heavily, or it can include categorization information associated with one or more the samples that can be used as a figure of merit.

The techniques described above can also be applied to determine the uniformity of a pharmaceutical compound that is in the form of dosage units. This approach can allow the system to acquire information about the uniformity of the mixture within each unit and/or across a lot of units, and the sampling can take place before or after the dosage units are packaged in transparent blister packs. Relevant techniques for this type of measurement can be found in U.S. Pat. No. 6,690,464, which is herein incorporated by reference. Staining techniques may also help to enhance the information received from some experimental runs. These techniques are described in U.S. application Ser. No. 11/265,796, published under WO2006044861, and herein incorporated by reference. Moreover, while the techniques presented above have been developed for use in the characterization of pharmaceuticals, they may also be applicable to other types of products, such as cosmetics or nutritional supplements. Coated goods, drug delivery systems, medical devices, and composite materials may also be inspected using systems according to the invention.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. A spectroscopic method, including:
acquiring a plurality of separate spectral measurements at different locations on a sample,
evaluating results of the measurements based on one or more predetermined test criteria,
categorizing information from measurements made at the different locations based on results of the step of evaluating, and
reporting results that include information from both the step of acquiring and the step of categorizing.

2. The method of claim 1 wherein the step of categorizing is performed by rejecting one or more measurements that fail to satisfy the predetermined test criteria.

3. The method of claim 1 wherein the step of categorizing is performed by classifying the measurements into a plurality of discrete categories.

4. The method of claim 1 wherein the step of categorizing is performed by associating the measurements with categorization information.

5. The method of claim 1 wherein the predetermined test criteria are statistical test criteria.

6. The method of claim 1 wherein the step of categorizing includes the steps of retaining measurements for the locations that meet the predetermined test criteria and rejecting measurements for the locations that fail to meet the predetermined test criteria.

7. The method of claim 6 further including the step of deriving one or more statistical properties of the categorized measurements.

8. The method of claim 7 wherein the step of deriving statistical properties includes a step of averaging the categorized measurements.

9. The method of claim 7 wherein the step of deriving statistical properties includes a step of obtaining a standard deviation for the categorized measurements.

10. The method of claim 7 wherein the step of deriving statistical properties includes a step of obtaining a kurtosis value for the categorized measurements.

11. The method of claim 7 wherein the step of deriving statistical properties includes a step of obtaining a skew value for the categorized measurements.

12. The method of claim 1 further including the step of deriving one or more statistical properties of the categorized information.

13. The method of claim 12 wherein the step of deriving statistical properties includes a step of averaging the categorized information.

14. The method of claim 1 wherein the step of acquiring includes acquiring scout measurements and test measurements and wherein the step of categorizing includes retaining information from test measurements at locations that satisfy the test criteria in the scout measurements.

15. The method of claim 1 wherein the measurements include Raman measurements.

16. The method of claim 15 wherein the step of evaluating results of the measurements is adapted to detect fluorescence, and the step of categorizing is operative to reject measurements where fluorescence is detected.

17. The method of claim 16 wherein the step of evaluating detects measurements that exceed a predetermined intensity threshold.

18. The method of claim 1 wherein the sample is moved relative to the detector to allow the detector to acquire the separate spectroscopic measurements from the different locations.

19. The method of claim 1 wherein the steps of acquiring are performed using at least one moving minor.

20. The method of claim 19 wherein the moving mirror images at least a portion of an illuminated area of the sample onto an aperture between the sample and the detector.

21. The method of claim 1 wherein the steps of acquiring and deriving are performed for a pharmaceutical mixture.

22. The method of claim 21 wherein the steps of acquiring and deriving are performed for a pharmaceutical product.

23. The method of claim 21 wherein the steps of acquiring and deriving are performed for a pharmaceutical intermediate.

24. The method of claim 21 wherein the steps of acquiring and deriving are performed for a pharmaceutical dosage unit.

25. The method of claim 1 wherein the step of acquiring acquires a Raman measurement.

26. The method of claim 25 wherein the sample is moved relative to the detector to allow the detector to acquire the sampled spectroscopic measurements from the different locations.

27. The method of claim 1 wherein the size of the samples is on the order of the milled ingredient size for a pharmaceutical mixture.

28. The method of claim 1 wherein the size of the samples is on the order of the domain sizes of individual species in a pharmaceutical mixture.

29. The method of claim 1 wherein the size of the samples is on the order of 10 microns.

30. The method of claim 1 wherein the size of the samples is on the order of 125 microns.

31. The method of claim 1 wherein the size of the samples ranges from 0.5 microns to 1000 microns.

32. A spectroscopic apparatus for monitoring heterogeneity of a sample, comprising:
a sampling detector operative to acquire sampled spectroscopic measurements distributed over a range of different locations in a sample,
a sequencer operative to cause the same sampling detector to successively acquire samples for each of a plurality of locations in the sample, and
a spectral processor operative to derive from the sampled spectroscopic measurements a statistical measure of chemical heterogeneity.

33. A spectroscopic apparatus for monitoring heterogeneity of a sample, comprising:
means for acquiring sampled spectroscopic measurements distributed over a range of different locations in a sample,
means for causing the sampling detector to successively acquire samples for each of a plurality of locations in the sample, and
means for deriving from the sampled spectroscopic measurements a statistical measure of chemical heterogeneity.
